(19) United States
(12) Patent Application Publication
(10) Pub. No.: US 2022/0029648 A1
(43) Pub. Date: Jan. 27, 2022

(54) VAULT COVER AND A METHOD THEREFOR

(71) Applicant: Telefonaktiebolaget LM Ericsson (publ), Stockholm (SE)

(72) Inventors: Markus RINGSTRÖM, Enebyberg (SE); Henrik ASPLUND, Stockholm (SE)

(21) Appl. No.: 17/296,673

(22) PCT Filed: Nov. 30, 2018
(86) PCT No.: PCT/SE2018/051234

§ 371 Date: May 25, 2021

(51) Int. Cl. H04B 1/03; H04B 7/10; H04B 7/0413

(52) U.S. Cl. CPC H04B 1/03; H04B 7/0413; H04B 7/10

(57) ABSTRACT

There is provided a vault cover and a method for a vault cover covering a vault. The vault includes at least part of a radio transmitter unit for a communications network. The vault cover includes an integrated transmission grating configured to govern the propagation direction of radio waves transmitted through the vault cover. The method includes generating, using the radio transmitter unit and the integrated transmission grating, radio waves for the communications network. The radio waves are transmitted through the vault cover in the propagation direction governed by the integrated transmission grating.

### TECHNICAL FIELD

Embodiments presented herein relate to a method for vault cover and to a vault cover including an integrated transmission grating.

### BACKGROUND

In dense urban areas telecom operators may be faced with the challenge to add capacity in their networks. To mitigate this, Ericsson recently launched the Vault Radio 2268. The Vault Radio 2268 is designed to be installed e.g. underground in vaults such as manholes. The underground radio can be connected to external antennas above ground.

Alternatively, there are solutions where the antenna is integrated into the manhole lid. In those solutions, the manhole lid is made of dielectric material instead of metals such as cast iron.

An advantage with these solutions is that the visual impact of the radio disappears because the radio can be located underground. However, the antenna and the connection between the antenna and the radio will still be visible because they are located above ground.

It would further be difficult to have the antennas mounted in the vault because vault covers, e.g. manhole covers, are typically made of metal which blocks radio waves and connecting the antennas with the radio using cables and wires will be challenging. The signal would be attenuated, and this would decrease the signal strength outside the vault too much. Also, solutions where the manhole covers are made of materials which do not block radio would not be practical because these materials, e.g. dielectrics, could not provide the mechanical properties needed for manhole covers.

### SUMMARY

An object of embodiments herein is to provide a solution to the problems disclosed in the above.

According to a first aspect there is presented a method for a vault cover covering a vault. The vault includes at least part of a radio transmitter unit for a communications network. The vault cover includes an integrated transmission grating configured to govern the propagation direction of radio waves transmitted through the vault cover. The method includes generating, using the radio transmitter unit and the integrated transmission grating, radio waves for the communications network. The radio waves are transmitted through the vault cover in the propagation direction governed by the integrated transmission grating.

According to a second aspect there is presented a vault cover configured to cover a vault. The vault comprises at least part of a radio transmitter unit for a communications network 100a. The vault cover includes an integrated transmission grating for radio waves. The integrated transmission grating is configured to govern the propagation direction of radio waves transmitted through the vault cover. The radio waves are transmitted by the radio transmitter unit.

By integrating a transmission grating in the vault cover, the radio, the antenna or antennas, and the connections between the two, can be mounted in the vault. This increases the possibility to deploy new sites substantially because the radio and the antennas can be hidden and do not interfere with the surroundings, which can otherwise be an obstacle to adding capacity by deploying transmission sites such as for example base stations.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 illustrating a communications network according to embodiments;

FIG. 2 schematically illustrates a vault cover covering a vault according to some embodiments;

FIG. 3 schematically illustrates a vault cover according to some embodiments;

FIG. 4 schematically illustrates a radiation pattern from a vault cover;

FIG. 5 schematically illustrates a vault cover and MIMO radiation pattern according to some embodiments;

FIG. 6 schematically illustrates a vault cover according to some embodiments;

FIG. 7 is a flowchart of methods according to embodiments;

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

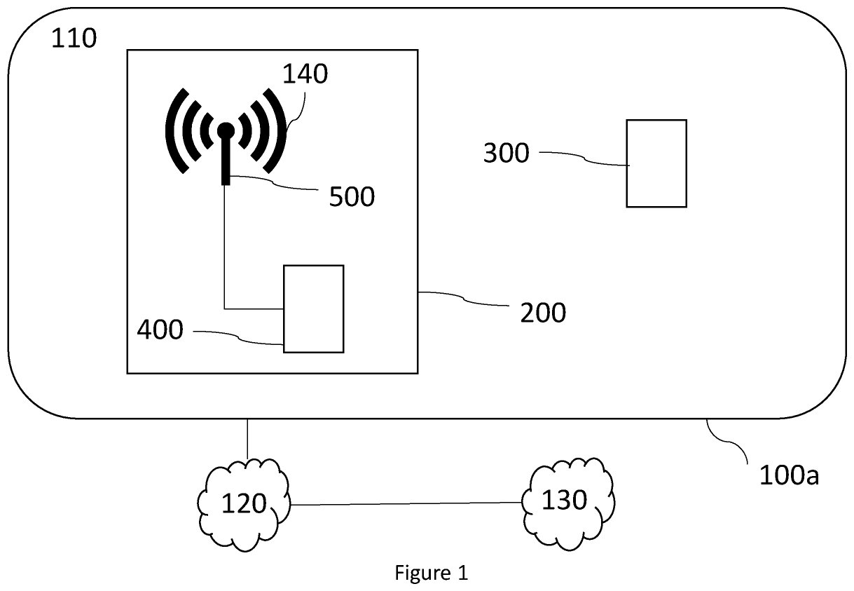

FIG. 1 is a schematic diagram illustrating a communications network 100a where embodiments presented herein can be applied. The communications network 100a could be a third generation (3G) telecommunications network, a fourth generation (4G) telecommunications network, or a fifth (5G) telecommunications network and support any 3GPP telecommunications standard. The communications network could also be a WiFi network, a Bluetooth network or other short range communications network.

In some embodiments the communications network 100a comprises a radio transmitter unit 200 configured to, in a radio access network 110, provide network access to a radio receiver unit 300 implemented as a terminal device such as a user equipment (UE) or a wireless communication device. The radio access network 110 is operatively connected to a core network 120. The core network 120 is in turn operatively connected to a service network 130, such as the Internet. Radio receiver unit 300 is thereby, via radio transmitter unit 200, enabled to access services of the service network 130. A radio transmitter unit 200 may be, or may be part of, a network node such as radio access network nodes, radio base stations, base transceiver stations, Node Bs, evolved Node Bs, g Node Bs, access points, access nodes, antenna integrated radios (AIRs), and transmission and reception points (TRPs). Examples of terminal devices are wireless devices, mobile stations, mobile phones, handsets, wireless local loop phones, user equipment (UE), smartphones, laptop computers, tablet computers, network equipped sensors, network equipped vehicles, and so-called Internet of Things devices.

Radio transmitter unit 200 provide network access in the radio access network 110 by transmitting signals to radio receiver unit 300 in beams 140. The radio transmitter unit may include a radio unit 400 and an antenna unit 500. The radio transmitter unit generates radio waves that forms signals for the communication networks 100a. The signals could be transmitted from the antenna unit 500, forming part of a transmission point, of the radio transmitter unit 200. Radio waves are generated by radio transmitters and received by radio receivers, using antennas. Radio waves are widely used in modern technology for fixed and mobile radio communication, broadcasting, radar and other navigation systems, communications satellites, wireless computer networks and many other applications. In communication networks, information is carried across space using radio waves. At the sending end, the information to be sent, in the form of a time-varying electrical signal, is applied to a radio transmitter. The information signal, formed by the radio wave, may be an audio signal representing sound from a microphone, a video signal representing moving images from a video camera, or a digital signal representing data from a computer but not limited thereto.

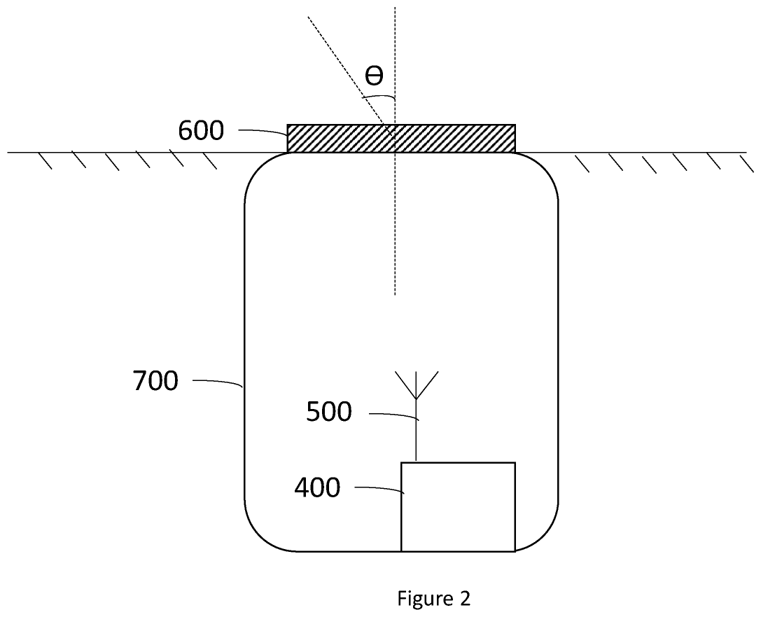

FIG. 2 schematically illustrates embodiments disclosed herein. A transmission grating in has been integrated in the vault cover 600. The transmission grating may include a grating which is governed by the equation:

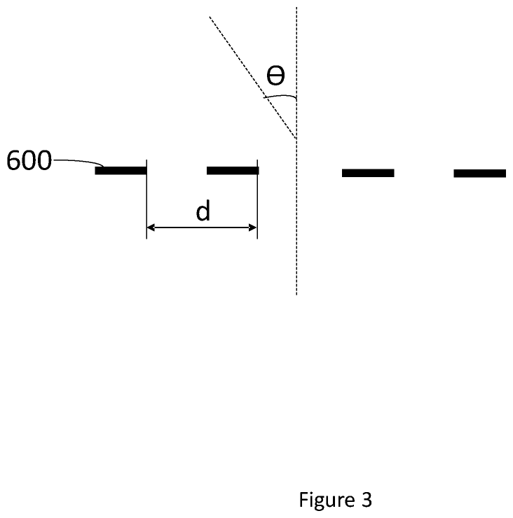

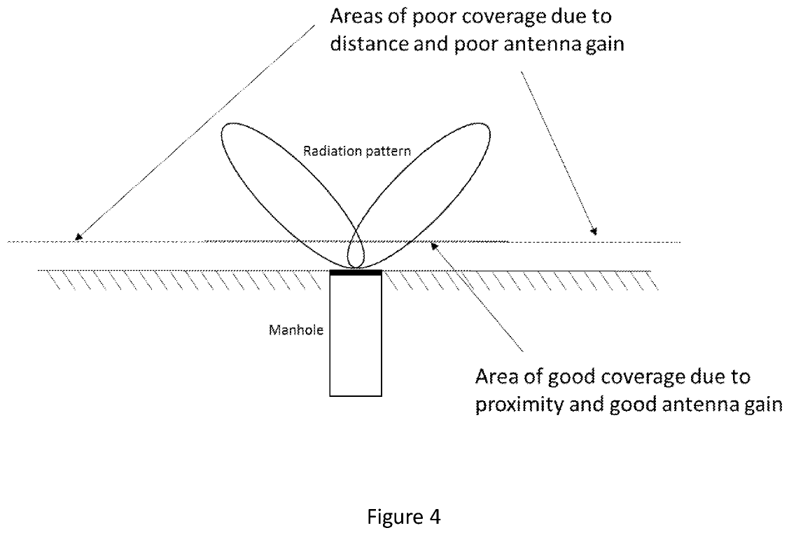

d sin θ=mλ (1)

where d is the distance between the slits of the grating, θ is the angle between the direction of radio wave and the normal of the vault cover and λ is the wavelength (m is an integer, the so-called propagation mode). According to some embodiments the angle θ may be be interpreted as the tilt angle in a traditional deployment. A vault cover including an integrated transmission grating having slit distance, d, is illustratively shown in FIG. 3. Further in some embodiments the transmission grating may be adapted to the frequency of the radio signal transmitted using the antenna unit 500. Therefore, given a certain radio frequency, the angle θ can be chosen arbitrarily. This may also be explained such that a given fixed transmission grating may support a certain frequency range with different carriers transmitted at different angles through the manhole cover. Designing the transmission grating such that the transmission angles is exactly 0 is not necessary in many embodiments. In dense urban areas subsequent reflections will anyhow spread the radio signal in several directions. If the manhole covers where designed with holes to let the radio waves pass through in the top part and/or close to the edges this would have the drawback that the radio waves would mostly propagate in unfavourable directions, such as perpendicular to the manhole cover (straight into the sky), resulting for example in poor area coverage, especially at larger distances as (cf FIG. 4).

In some embodiments the transmission grating integrated in the vault cover is protected with suitable protection cover to avoid it being damaged or worn. The integrated transmission grating may contain fine structures and may therefore be sensitive to mechanical wear or of being broken.

The vault 700 is in some embodiment a spacing or hollow in dense urban areas where at least part of the radio unit 400 and at least part of the antenna unit 500 can be placed without interfering or disturbing the surrounding aesthetically. In some embodiments the vault is a manhole and in other embodiments the vault is accessed through a manhole. The vault may be an underground utility vault used to house an access point for making connections, inspection, valve adjustments or performing maintenance on underground and buried public utility and other services including water, sewers, telephone, electricity, storm drains, district heating and gas. The vault may be accessed through an opening, where the opening usually is circular in shape but not limited thereto. The opening may be a manhole and is covered by a vault cover such as a manhole cover. A vault cover 600, or a manhole cover, is a removable plate forming the lid over the opening of for example a manhole. By integrating a transmission grating in the vault cover, the radio unit 400, the antenna unit 500 or antenna units, and the connections between the two, can be mounted in the vault. This increases the possibility to deploy new sites substantially.

A vault cover 600 may be configured to cover a vault. The vault includes at least part of a radio transmitter unit a communications network 100a, thus either the antenna unit and/or the radio unit and/or part of the antenna unit and/or part of the radio unit resides within the vault. The connection between the antenna unit and the radio unit may also reside partly or entirely within the vault. The radio transmitter unit or part of the radio transmitter unit may also not be visible from the outside and/or may not interfere with the surroundings. The vault cover includes an integrated transmission grating for radio waves. The integrated transmission grating is configured to govern the propagation direction of radio waves transmitted through the vault cover. The radio waves are transmitted by the radio transmitter unit.

The vault cover 600, or the manhole cover, design proposed herein may have higher attenuation than a traditional site solution using over-ground antennas, but it offers more possibilities to deploy sites in dense urban areas, where site acquisition may otherwise be challenging.

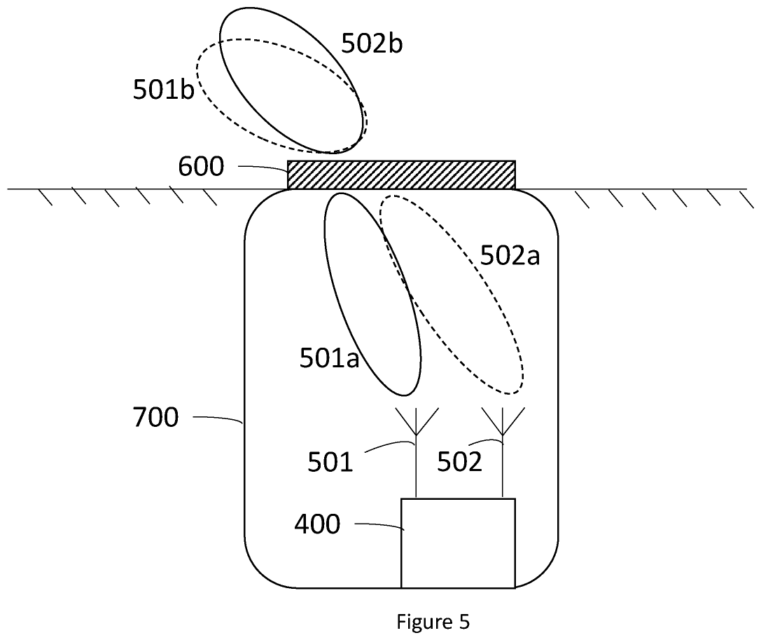

MIMO (Multiple Input Multiple Output) communications are easily supported through the installation of at least two or more antennas (501, 502) at different positions within the vault 700. Thus, it is expected that a single vault may support higher order MIMO up to the extent given by the dimensions of the vault with respect to the wavelength. FIG. 5 illustratively shows two MIMO antenna units (501 and 502) that generates two radiation patterns (501a and 502a). After transmission through the vault cover 600 with integrated transmission grating and after being diffracted by the transmission grating the resulting radiation patterns (501b and 502b) are illustratively depicted in FIG. 5. The MIMO communication can be supported by using at least two or more MIMO antennas inside the vault. MIMO may be supported by positioning the antennas at different positions, the antennas may also have different polarizations and/or using different pointing directions, as illustrated in FIG. 5.

The pattern of the transmission gratings may be circularly symmetric to create a mostly uniform coverage in azimuth, or alternatively it can be tailored to specific directions. For example, for a vault or manhole installed in a street crossing with four principal directions the transmission grating integrated in the vault cover may be designed such the radio signal is most prominent in the four principal directions of the street crossing. For a street canyon the radio signal may be most prominent in the two principal directions of the street canyon.

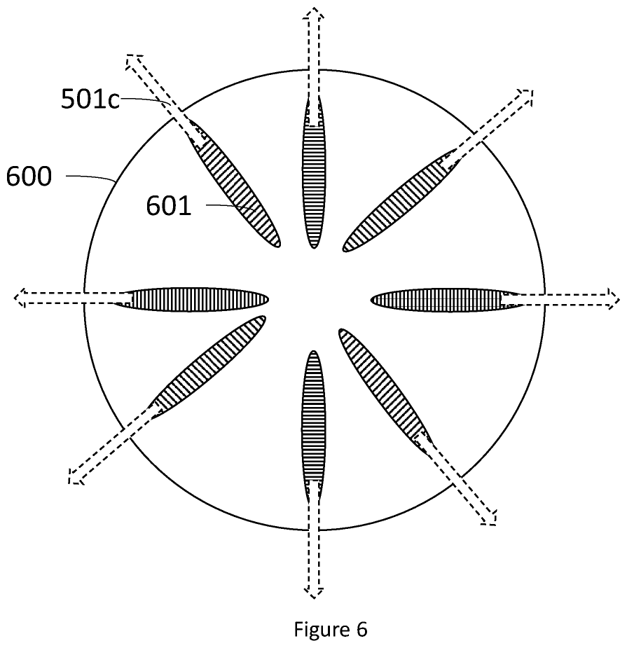

An exemplary vault cover 600 with integrated transmission grating is illustrated in FIG. 6. The exemplary vault cover 600 includes integrated transmission gratings 601. The transmission grating may cover the entire vault cover area or it may cover selected areas of the vault cover, as shown in FIG. 6. The design of the integrated transmission grating governs the propagation direction of the diffracted radio waves (501c). The size, shape, orientation, and gratings of the integrated transmission grating illustrated in FIG. 6 is an exemplary embodiment but the disclosure herein is not limited thereto and other transmission grating designs are also part of the embodiments.

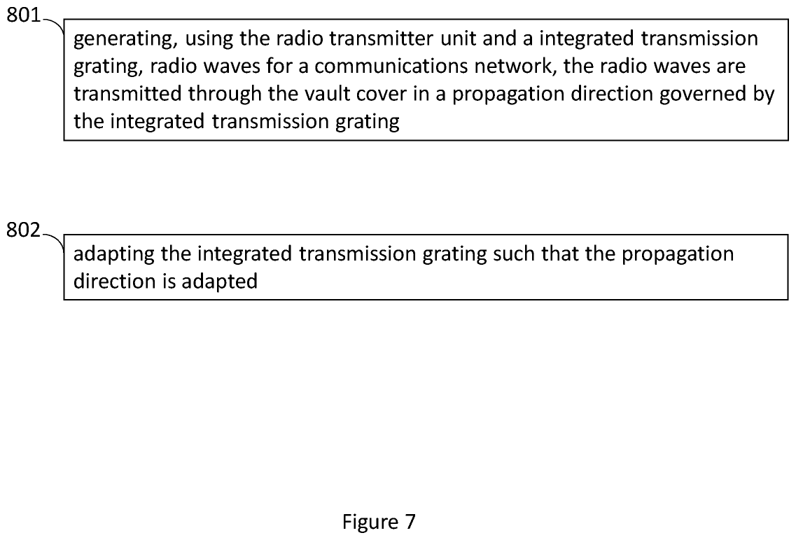

FIG. 7 is a flowchart illustrating embodiments of methods for a vault cover covering a vault, where the vault includes at least part of a radio transmitter unit for a communications network 100a, step 801. The vault cover also includes an integrating transmission grating according to the embodiments disclosed herein. The vault cover is configured to govern the propagation direction of radio waves transmitted through the vault cover according to the embodiments disclosed herein. The method includes generating, using the radio transmitter unit and the integrated transmission grating, radio waves that can be used in the for the communications network 100a. The radio waves are transmitted through the vault cover in the propagation direction governed by the integrated transmission grating. The propagation direction may be determined by the design of the transmission grating as disclosed in the embodiments herein. In step 802, the integrated transmission grating adapted such that the propagation direction of the radio waves is adapted. This may be achieve using the embodiments described herein such as adapted the design of the integrated transmission grating.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for a vault cover covering a vault, the vault comprising at least part of a radio transmitter unit for a communications network, the vault cover having an integrated transmission grating configured to govern the propagation direction of radio waves transmitted through the vault cover, the method comprising:
generating, using the radio transmitter unit and the integrated transmission grating, radio waves for the communications network, the radio waves being transmitted through the vault cover in the propagation direction governed by the integrated transmission grating.

2. The method according to claim 1, further comprising:
adapting the integrated transmission grating such that the propagation direction is adapted.

3. The method according to claim 1, wherein the vault cover is a manhole cover.

4. The method according to claim 1, wherein the radio transmitter unit comprises a radio unit and an antenna unit.

5. The method according to claim 1, wherein the integrated transmission grating comprises a grating spacing, d, and wherein the propagation direction is governed by the grating spacing, d, and the frequency of the radio waves.

6. The method according to claim 1, wherein the integrated transmission grating is integrating into the vault cover and covered by protective cover.

7. The method according to claim 1, wherein the radio transmitter unit is configured for MIMO communication.

8. A vault cover configured to cover a vault, the vault comprising at least part of a radio transmitter unit for a communications network, the vault cover comprising:
an integrated transmission grating for radio waves, wherein the integrated transmission grating is configured to govern the propagation direction of radio waves transmitted through the vault cover by the radio transmitter unit.

9. The vault cover of claim 8, wherein the vault cover is a manhole cover.

10. The vault cover of claim 8, wherein the radio transmitter unit comprises a radio unit and an antenna unit.

11. The vault cover of claim 8, wherein the integrated transmission grating comprises a grating spacing, d, and wherein the propagation direction is governed by the grating spacing, d, and the frequency of the radio waves.

12. The vault cover of claim 8, wherein the integrated transmission grating is integrated into the vault cover and covered by protective cover.

13. The vault cover of claim 8, wherein the radio transmitter unit is configured for MIMO communication.

14. The vault cover of claim 8, wherein the radio transmitter unit comprises at least two MIMO antenna units.

15. The vault cover of claim 14, wherein the at least two MIMO antenna units are at different positions and providing different polarizations or different pointing directions.

16. The method according to claim 2, wherein the vault cover is a manhole cover.

17. The method according to claim 2, wherein the radio transmitter unit comprises a radio unit and an antenna unit.

18. The method according to claim 2, wherein the integrated transmission grating comprises a grating spacing, d, and wherein the propagation direction is governed by the grating spacing, d, and the frequency of the radio waves.

19. The method according to claim 2, wherein the integrated transmission grating is integrating into the vault cover and covered by protective cover.

20. The method according to claim 2, wherein the radio transmitter unit is configured for MIMO communication.
